(19) United States
(12) Patent Application Publication
(10) Pub. No.: US 2010/0029297 A1
(43) Pub. Date: Feb. 4, 2010

(54) WIRELESS DATA COMMUNICATION SYSTEM AND METHOD FOR PROVIDING WIRELESS DATA SERVICE TO SDR TERMINAL

(75) Inventors: Jun Sik Kim, Daejeon (KR); Nam Hoon Park, Daejon (KR); Dae Sik Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications, Daejeon (KR)

(21) Appl. No.: 12/517,456

(22) PCT Filed: Dec. 4, 2007
(86) PCT No.: PCT/KR07/06256

§ 371 Date: Jun. 3, 2009

(30) Foreign Application Priority Data
Dec. 7, 2006 (KR) 10-2006-0124058

(51) Int. Cl. H04W 24/00

(52) U.S. Cl. 455/456.1

(57) ABSTRACT

A wireless data communication system includes a software defined radio (SDR) terminal having a wireless map, and accessing a desired wireless data service using the wireless map, wherein the wireless map includes GPS location information, information on wireless data services available at a current location of the SDR terminal based on the GPS location information and information on wireless connection software components for each wireless data service selected by the SDR terminal. The wireless data communication system further includes a base station for providing a wireless connection environment, an authentication center for authenticating the SDR terminal, a download server for providing the wireless connection software component to the SDR terminal, and a location-based service server for providing the wireless map to the SDR terminal.

### TECHNICAL FIELD

The present invention relates to wireless data communications, and more particularly, to a wireless data communication system and method of providing wireless data service to software defined radio (SDR) terminal.

This work was supported by the IT R&D program of MIC/IITA. [2006-S-012-01, Development of Middleware Platform Technology based on the SDR Mobile Station]

### BACKGROUND ART

With the development of mobile communications and the spread of wireless data, broadcasting and Internet services, several standards of wireless broadcasting and wireless data services, such as wireless local area network (LAN), global positioning system (GPS), evolution-data optimized (EV/DO), digital multimedia broadcasting (DMD), WIBRO, and high speed downlink packet access (HSDPA) services, apart from voice service, are being provided by several service providers. These wireless data services are differentiated in service area, usage, performance, and cost. The same service may be provided in several wireless connection ways by different service providers even at the same place. Thus, a user needs to select and utilize one among the wireless data services using wireless connection software suitable to access the selected wireless data service. Accordingly, a strong need for multi-mode terminals is arise, and a software defined radio (SDR) terminal to cope with the need comes into the spotlight.

A multi-mode terminal is embedded therein a wireless modem and its relevant program and is operated in a way of switching wireless connection mode with a user's choice. Therefore, it is unnecessary for the multi-mode terminal to download wireless connection software except software debugging, added service, subscription to new services, software upgrade and the like. Further, even though existing wireless connection software is newly updated, a new version thereof may be updated by download on-line or offline. That is, the download is confined a limited range.

Meanwhile, a data service-oriented SDR terminal can provide multi-mode service only with changed software. That is, use of the SDR terminal enables a user-selected wireless data service in several wireless connection environments without needing to change hardware in the SDR terminal.

Basically, the SDR terminal is designed to download wireless connection software so that it accesses a wireless data service using the downloaded wireless connection software. The wireless connection software is provided on a component basis and is available, for example, via a wired cable, wirelessly, or from a storage device of the SDR terminal.

Moreover, in a case of wireless data service based on a conventional mobile communication network, wireless data service is available over all areas because location information of subscriber who posses a mobile terminal is registered and managed for call service. Accordingly, the subscriber can easily access the wireless data service available at a current location anywhere and any time by connecting to the mobile communication network.

However, in a case of wireless data service that is provided only at a hot spot using, for example, a notebook, or in a case of wireless data service that does not provide call service and manage location information, it is difficult to utilize the wireless data service depending on the location information.

### DISCLOSURE OF INVENTION

### Technical Problem

It is, therefore, an object of the present invention to provide a wireless data communication and method capable of providing a wireless data service to a software defined radio (SDR) terminal based on location information.

### Technical Solution

Another object of the present invention is to provide an SDR terminal method capable of accessing a wireless data service depending on location information.

In accordance with an aspect of the present invention, there is provided a wireless data communication system, which includes:

a software defined radio (SDR) terminal having a wireless map, and accessing a desired wireless data service using the wireless map, wherein the wireless map includes GPS location information, information on wireless data services available at a current location of the SDR terminal based on the GPS location information and information on wireless connection software components for each wireless data service selected by the SDR terminal;

a base station for providing a wireless connection environment;

an authentication center for authenticating the SDR terminal;

a download server for providing the wireless connection software component to the SDR terminal; and

a location-based service server for providing the wireless map to the SDR terminal.

In accordance with another aspect of the present invention, there is provided a method for providing wireless data service to an SDR terminal in a wireless data communication system, which includes the steps of:

receiving a wireless map, the wireless map having information on wireless data services available at a current location of the SDR terminal, and information on wireless connection software component for each wireless data service;

selecting a desired wireless service among the wireless data services; and

accessing the selected wireless data service using the wireless connection software component for the selected wireless data service.

In accordance with further another aspect of the present invention there is provided a SDR terminal for use in a wireless data communication system, which includes:

a GPS receiver for receiving a GPS location information;

a memory unit having the wireless map stored therein, the wireless map having the GPS location information, information on wireless data services available at a current location of the SDR terminal based on the GPS location information, and information on wireless connection software component for each wireless data service; and

a wireless connection module for accessing a wireless data service selected among the wireless data services using the wireless connection software component for the selected wireless data service.

### ADVANTAGEOUS EFFECTS

As described above, in accordance with present invention, the SDR terminal 10 executes the GPS application component to receive GPS location information and selects a desired wireless data service at a current location, so that the desired wireless data service can be efficiently provided to the SDR terminal.

The user authentication and billing are performed on downloading the wireless connection software component apart from the use of the wireless data service, thereby preventing download of unnecessary wireless connection software component.

### BRIEF DESCRIPTION OF THE DRAWINGS

The above and other objects and features of the present invention will become apparent from the following description of embodiments given in conjunction with the accompanying drawings, in which:

FIG. 1 illustrates a wireless data communication system for use with an SDR terminal in accordance with an embodiment of the present invention;

FIG. 2 illustrates exemplary information constituting the wireless map provided to a SDR terminal shown in FIG. 1;

FIG. 3 illustrates a logical configuration for authentication in the SDR terminal shown in FIG. 1;

FIG. 4 illustrates a logical configuration of the SDR terminal shown in FIG. 1;

FIG. 5 is a flowchart illustrating a method of providing wireless data service using an SDR terminal in accordance with an embodiment of the present invention; and

FIG. 6 is a flowchart illustrating authentication procedure performed during the wireless data service in accordance with an embodiment of the present invention.

### BEST MODE FOR CARRYING OUT THE INVENTION

Hereinafter, embodiments of the present invention will be described in detail with reference to the accompanying drawings so that they can be readily implemented by those skilled in the art.

FIG. 1 illustrates a wireless data communication system for use with an SDR terminal in accordance with an embodiment of the present invention.

As shown in FIG. 1, the wireless data communication system includes an SDR terminal 10 capable of receiving GPS location information via a GPS satellite 30 and accessing a desired wireless data service using the GPS location information, a base station 20 for providing a wireless connection environment, and a wire/wireless network 40 connected to the base station 20.

The wire/wireless network 40 includes an authentication center 50 for authenticating the SDR terminal 10, a download server 60 for providing wireless connection software components to the SDR terminal 10, a location-based service server 70 for facilitating a location-based service by providing a wireless map to the SDR terminal 10, all of which are connected with each other in a wired cable such as the Internet, or in wireless.

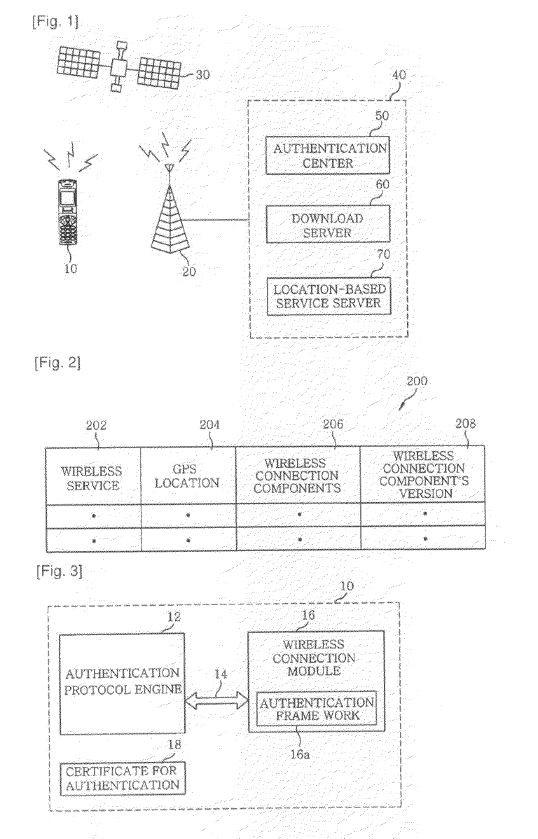

FIG. 2 illustrates an exemplary of information constituting the wireless map provided to the SDR terminal in accordance with present invention.

The wireless map 200 includes information on a list 202 of wireless data services available at a current location of the SDR terminal 10, and GPS location information 204. The wireless map 200 further includes a list 206 of a wireless connection software component for each wireless data service, and a version 208 of the wireless connection software components. The wireless map 200 is provided from the location-based service server 70 upon a user's request. When the SDR terminal 10 is under wireless data service, the wireless map 200 may be periodically updated upon a request of the user or via a broadcasting channel. Further, the SDR terminal 10 compares a version of the wireless connection software component downloaded therein with that of those in the list. When a high-level version exists in the list, the SDR terminal 10 downloads it for software upgrade.

A current location of the SDR terminal 10 is analyzed based on the GPS location information 204 and the list 102 of the wireless data services available at the current location is represented on a screen of the SDR terminal 10 so that a user selects his/her desired wireless data service.

If the wireless connection software component required to access the wireless data service has been already downloaded in the SDR terminal 10, the SDR terminal 10 may immediately attempt to access the wireless data service using the wireless connection software component. However, when there is no wireless connection software component downloaded in the SDR terminal 10, the SDR terminal 10 selects the wireless connection software component in the list 206 and requests to download the wireless connection software component from the download server 60.

However, if there is no available wireless connection software component at the current location of the SDR terminal due to a user's movement to another area, the user may acquire the wireless connection software component via a wired cable or others.

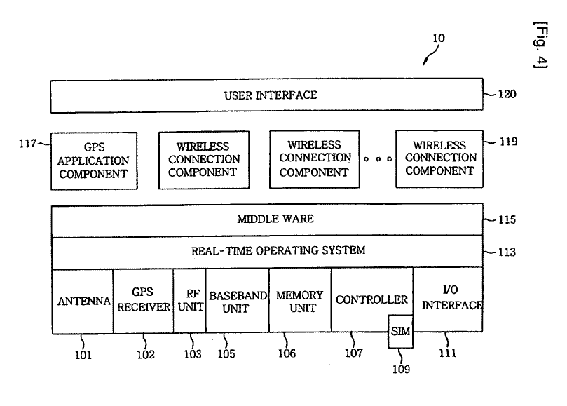

FIG. 3 illustrates a logic configuration for authentication of the SDR terminal shown in FIG. 1.

As shown in FIG. 3, the logic configuration for authentication in the SDR terminal 10 includes a certificate of authentication 18, an authentication protocol engine 12 having authentication protocols (e.g., EAP-MD5 (Extensible Authentication Protocol-Message Digest 5), EAP-TLS (Transport Level Security), and EAP-TTLS (tunneled TLS)) available in the wireless data communications to display the list of the authentication protocols on a screen of the SDR terminal 10 for user's selection.

The authentication protocols are based on the IEEE 802.1x standard (802 privacy), in which a user terminal and an authentication server exchange user ID and password to and from each other through EAP to determine whether the user is an authorized one. The EAP can accommodate various schemes, such as MD5, TLS, and TTLS.

The SDR terminal 10 further includes a wireless connection module 16 connected with the authentication protocol engine 12 via a standard interface, such as an internal system bus, a USB (universal serial bus), a PCMIA (personal computer memory card international association), or the like. The wireless connection module 16, which may be configured of an SDR-based software component, generates an EAP message and includes an authentication framework 16a having the 802 privacy and the like.

In a conventional wired/wireless data service, mobile terminals suffice to undergo subscriber authentication for a service use. In the meantime, for the SDR terminal 10 of the present invention, in downloading the wireless connection software component, it is needed to get the approval to the use of the wireless connection software component through the authentication center 50. For the approval, firstly, a user ID and password is provided for the user identification to a subscriber authentication module such as a SIM (Subscriber Identification Module) in the SDR terminal 10. After the user identification, the wireless connection software component is downloaded, and the SDR terminal 10 tries to access the wireless data service using the downloaded wireless connection software component. Next, user information including an MD-5 based user ID and password is provided to the authentication center 50 to obtain the approval to use the wireless data service. Finally, when the wireless connection is successful upon accessing, a user authentication for the SDR terminal 10 is performed based on the certificate 18 for authentication by the authentication server 50. In these approval processes, a billing procedure may be performed to reduce unnecessary downloads.

FIG. 4 illustrates a logical configuration of the SDR terminal shown in FIG. 1.

As shown in FIG. 4, the SDR terminal 10 includes hardware components such as an antenna 101, a GPS receiver 102, an radio frequency (RF) unit 103, a baseband unit 105, a memory unit 106, a controller 107, which may be implemented with a digital signal processor (DSP) and a general-purpose processor, a SIM card 109 having the certificate for authentication 18 and user information such as user ID and password, and an input/output (I/O) interface 111.

The SIM card 109 is detachably mounted to the SDR terminal 10 and is connected therewith via a standard interface.

The I/O interface 111 may be a general-purpose standard interface, such as USB and PCMCIA. For a notebook PC or a PDA (personal digital assistant), the I/O interface 111 may be a LAN (local area network) or a wireless LAN. Via the I/O interface 111, the SDR terminal 10 receives the wireless map 200 and the wireless connection software component for accessing the wireless data service. If it is difficult to download the wireless map 200 and the wireless connection software component in a wireless manner, they may be downloaded via a wired cable or others.

In addition, the SDR terminal 10 further includes software components such as a real-time operating system 113 for operating the SDR terminal 10, a middle ware 115 for efficient SDR operation, and a user interface 120. A GPS application component 117 and one or more wireless connection software components 119 are located on the middle ware 115.

The GPS application component 117 drives the GPS receiver 102 to receive the GPS location information. Some of the wireless connection software component components 119 may be previously downloaded or stored in the memory unit 106 in the SDR terminal 10. The wireless connection software component components 119 run to make a wireless connection in order to provide a user-selected wireless data service.

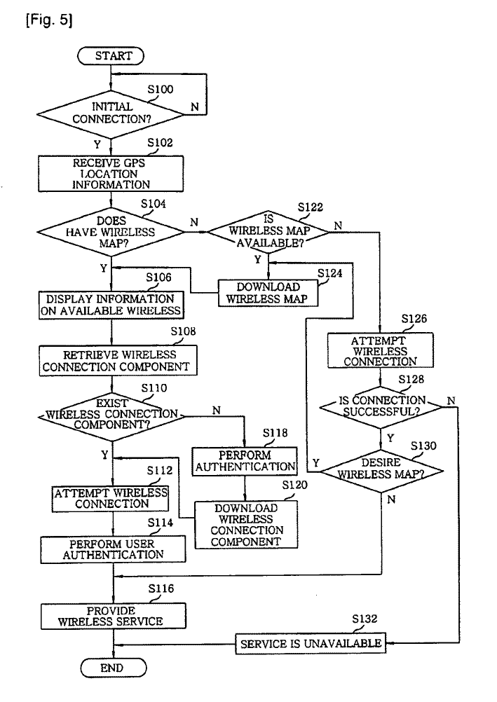

FIG. 5 is a flowchart illustrating a method for providing the wireless data service using the SDR terminal in accordance with the present invention.

First, the controller 107 determines whether or not the SDR terminal 10 is in an initial connection state where the SDR terminal 10 tries to access the wire/wireless network 40 via the base station 20 (S100).

If it is determined in step S100 that the SDR terminal 10 is in the initial connection, the controller 107 executes the GPS application component 117 to allow the GPS receiver 102 to receive the GPS location information through the GPS receiver 102 (S102).

Subsequently, the controller 107 determines whether or not the SDR terminal 10 has the wireless map 200 corresponding to the current location based on the GPS location information (S104).

If it is determined in step S104 that the SDR terminal 10 has the wireless map 200 corresponding to the current location, the controller 107 displays information on available wireless data services derived from the wireless map 200 on a screen via the user interface 120 to prompt a selection of a desired wireless data service (S106).

Thereafter, when the selection of the desired wireless data service is made by the user, the controller 107 retrieves a wireless connection software component 119 for the wireless data service selected by the user (S108). Next, it is determined that there exists the wireless connection software component in the SDR terminal 10 (S110).

If it is determined in step S110 that the SDR terminal 10 has the wireless connection software component, the controller 107 executes the wireless connection software component to attempt the wireless connection for the wireless data service (S112).

When the wireless connection is successful, a user authentication procedure is performed through the authentication center 50 before being started to provide the wireless data service (S114˜S116). Upon the user authentication, a billing way is also decided for the use of the wireless data service.

However, if it is determined in step S110 that the SDR terminal 10 does not have the wireless connection software component, the controller 107 requests to download the wireless connection software component from the download server 60. Before the download, it is necessary to determine how to download the wireless connection software component and to charge for the download of the wireless connection software component through the authentication based on the user ID and password (S118).

After that, the wireless connection software component for the wireless data service is downloaded to the SDR terminal 10 from the download server 60 (S120).

Next, a control process goes to step S112, as described above, where the SDR terminal 10 attempts the wireless connection using the downloaded wireless connection software component.

Meanwhile, if it is determined in step S104 that the SDR terminal 10 has no wireless map due to a user's movement to another area, it is determined in step S122 whether or not the wireless map 200 is available at the current location from the location-based service server 70.

If the wireless map 200 is available at the current location from the location-based service server 70, the controller 107 requests to the location-based service server 70 the wireless map 200 corresponding to the current location, and downloads the wireless map 200 from the download server 60 (S124).

However, if the wireless map 200 is not available in step S122, the controller 107 executes a network connection protocol which is currently being used in the SDR terminal 10 to attempt a wireless connection (S126).

Thereafter, if it is determined that the wireless connection is successful in step S128, the controller 107 determines in step S130 whether or not the user desires to use the wireless map 200 according to the present invention. In step S130, if YES, a control process returns to step S124, while if NO, a control process goes to step S116.

If, however, in step S128, the wireless connection is not successful, the wireless data service will not be available to the SDR terminal (S132).

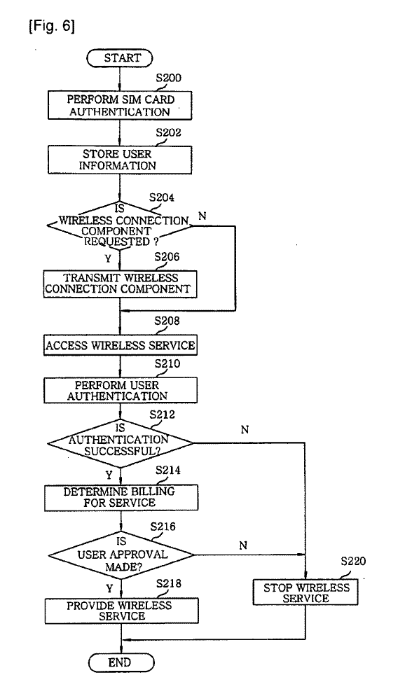

FIG. 6 is a flowchart illustrating authentication procedure performed during the wireless data service in accordance with an embodiment of the present invention.

First, when the SDR terminal 10 needs the wireless connection software component 119, an authentication for the SIM card 109 is performed in the SDR terminal 10 using the user ID and password provided through the user interface 120 (S200).

When the authentication is performed, the controller 107 sends user information including the user ID and password to the authentication center 50 via the base station 20, and the authentication center 50 then stores the received user information and allows for the download server 60 to permit the use of the wireless connection software component 119 (S202).

Thereafter, the download server 60 determines whether the SDR terminal 10 makes a request for the wireless connection software component 119 (S204).

If it is determined in step S204 that the SDR terminal makes a request for the wireless connection software component 119, the download server 60 transmits the wireless connection software component 119 to the SDR terminal 10 (S206).

Thereafter, the SDR terminal 10 tries a call connection to access the wireless data service using the downloaded wireless connection software component 119 (S208).

When the call connection is made, the authentication center 50 performs a user authentication for the SDR terminal 10 (S210).

It is determined in step S212 whether or not the user authentication is successful in the authentication center 50. If positive, a control process goes to step S214 where the download server 60 negotiates with the user for a billing for the use of the wireless connection software component.

Thereafter, if the user approval is made with respect to a determined billing in step S216, the wireless data service begins to the SDR terminal 10 (S218).

If, however, it is determined in both steps S212 and S216 that the user authentication and the user approval fail, the wireless data service would not be provided to the SDR terminal 10 (S220).

While the invention has been shown and described with respect to the preferred embodiments, it will be understood by those skilled in the art that various changes and modifications may be made without departing from the scope of the invention as defined in the following claims.

1. A wireless data communication system comprising:
a software defined radio (SDR) terminal having a wireless map, and accessing a desired wireless data service using the wireless map, wherein the wireless map includes GPS location information, information on wireless data services available at a current location of the SDR terminal based on the GPS location information and information on wireless connection software components for each wireless data service selected by the SDR terminal;
a base station for providing a wireless connection environment;
an authentication center for authenticating the SDR terminal;
a download server for providing the wireless connection software component to the SDR terminal; and
a location-based service server for providing the wireless map to the SDR terminal.

2. The system of claim 1, wherein the SDR terminal includes:
a GPS receiver for receiving the GPS location information;
a memory unit having the wireless connection software component therein provided from the download server; and
a wireless connection module for accessing the wireless data service using the wireless connection software component.

3. The system of claim 1, wherein the SDR terminal further includes:
a subscriber identification module (SIM) card for storing therein user information for the SDR terminal and a certificate of authentication, the user information being used to obtain the approval of the use of the wireless connection software component and the certificate of authentication being used to authenticate the SDR terminal for the wireless data service.

4. The system of claim 1, wherein the wireless map is periodically updated in response to a request of the SDR terminal when the SDR terminal is under the wireless data service.

5. The system of claim 1, wherein the wireless map is periodically updated via a broadcasting channel when the SDR terminal is under the wireless data service.

6. The system of claim 1, wherein the wireless connection software component is downloaded to the SDR terminal if the wireless connection software component does not available from the SDR terminal.

7. A method for providing wireless data service to an SDR terminal in a wireless data communication system, the method comprising the steps of:
receiving a wireless map, the wireless map having information on wireless data services available at a current location of the SDR terminal, and information on wireless connection software component for each wireless data service;
selecting a desired wireless service among the wireless data services; and
accessing the selected wireless data service using the wireless connection software component for the selected wireless data service.

8. The method of claim 7, further comprising the step of displaying the wireless map for the selection of the wireless data service and the wireless connection software component for the selected wireless data service.

9. The method of claim 8, further comprising the step of making a request for the wireless connection software component for downloading it if the SDR terminal does not have the wireless connection software component for the selected wireless data service.

10. The method of claim 7, further comprising, after the step of making a request for the wireless connection software component, performing an authentication for the approval of the use of the wireless connection software component.

11. The method of claim 7, further comprising, before the step of accessing the selected wireless data service using the wireless connection software component for the selected wireless data service, performing a user authentication of the SDR terminal and a billing for the wireless data service.

12. A SDR terminal for use in a wireless data communication system, the SDR terminal comprising:
a GPS receiver for receiving a GPS location information;
a memory unit having the wireless map stored therein, the wireless map having the GPS location information, information on wireless data services available at a current location of the SDR terminal based on the GPS location information, and information on wireless connection software component for each wireless data service; and
a wireless connection module for accessing a wireless data service selected among the wireless data services using the wireless connection software component for the selected wireless data service.

13. The SDR terminal of claim 12, wherein the wireless connection software component is downloaded to the SDR terminal if the SDR terminal does not have the wireless connection software component for the selected wireless data service.

14. The SDR terminal of claim 12, wherein the wireless map is periodically updated in response to a request of the SDR terminal when the SDR terminal is under the wireless data service.

15. The SDR terminal of claim 12, wherein the wireless map is periodically updated via a broadcasting channel when the SDR terminal is under the wireless data service.
